(19) United States
(12) Patent Application Publication
(10) Pub. No.: US 2010/0239331 A1
(43) Pub. Date: Sep. 23, 2010

(54) POSITION ERROR CORRECTING METHOD, POSITION ERROR CORRECTING APPARATUS, AND IMAGE FORMING APPARATUS INCLUDING THE POSITION ERROR CORRECTING APPARATUS

(76) Inventors: Tatsuya Miyadera, Osaka (JP); Yoshinori Shirasaki, Osaka (JP); Tomohiro Ohshima, Osaka (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/723,908

(22) Filed: Mar. 15, 2010

(30) Foreign Application Priority Data
Mar. 18, 2009 (JP) 2009-066452
Mar. 8, 2010 (JP) 2010-050375

(51) Int. Cl. G03G 15/01

(52) U.S. Cl. 399/301

(57) ABSTRACT

A position error correcting method includes forming an image-forming condition determination pattern on an endless transport unit transported in a first direction, the image-forming condition determination pattern including plural unit patterns having different unit-area attached toner amounts and arranged in the first direction; detecting a detection limit pattern having the minimum detectable unit-area attached toner amount from the unit patterns; calculating an image-forming condition of the detection limit pattern; forming a position error correction pattern on the endless transport unit in the first direction in accordance with the image-forming condition; and correcting a position error of a toner image formed on the endless transport unit by plural image forming units, using the position error correction pattern, wherein the position error is corrected with respect to a second direction perpendicular to the first direction.

### BACKGROUND OF THE INVENTION

1. Field of the Invention

The present invention generally relates to a position error correcting method and a position error correcting apparatus for reducing the amount of toner that becomes attached to a transport belt or an intermediate transfer belt and to an image forming apparatus including the position error correcting apparatus.

2. Description of the Related Art

Tandem-type image forming apparatuses such as tandem-type laser beam printers are known. Typically, such a tandem-type image forming apparatus includes plural image forming units for the four different colors of black (BK), magenta (M), cyan (C) yellow (Y). Toner images formed by the image forming units are superposed either directly on a printing sheet, such as a sheet of paper, or an intermediate transfer belt, thus forming a color image. In this case, if the positions of the toner images for the respective colors are displaced even a little, a stable color image cannot be obtained. A position error correction process may be performed whereby a position error correction pattern is formed for each color, and the toner image position for each color is detected using a detecting unit such as a TM (toner marking) sensor, so that all of the four colors can be accurately superposed at the same predetermined position.

The aforementioned position error correction pattern is passed through a detection position along with the movement of the transport belt or the intermediate transfer belt. After the position error correction pattern is detected by the TM sensor, the toner for the position error correction pattern on the transport belt or the intermediate transfer belt is scraped with a cleaning blade, for example, and collected as waste toner. However, the toner may remain on the transport belt or the intermediate transfer belt, or the toner may become attached to a secondary transfer roller (for transferring the toner to the sheet) of an intermediate transfer system. Such residual or attached toner may become attached to the printing sheet, thus staining the sheet and lowering image quality.

Thus, in order to eliminate the staining by such residual or attached toner, in addition to the cleaning mechanism employing the cleaning blade, a bias voltage may be applied to the transport belt or the intermediate transfer belt and/or the secondary transfer roller so as to collect the toner. Specifically, a bias voltage of the opposite polarity to the charge of the toner may be applied to the cleaning mechanism in order to remove the toner from the transport belt or the intermediate transfer belt. Alternatively, a bias voltage of the same polarity to the charge of the toner may be applied to the secondary transfer roller so that the toner can be adsorbed on the intermediate transfer belt and then scraped by the cleaning blade. When the toner has both positive and negative charges, the applied bias voltage may be caused to oscillate between positive and negative polarities, as discussed in JP Patent Nos. 2858735 and 2642351.

However, in the aforementioned conventional technologies, the time required for toner recovery by bias voltage application may result in an increase in the position error correction time, resulting in an increase in user downtime. Further, in an intermediate transfer system, while the attachment of toner to the secondary transfer roller may be eliminated by the addition of a contacting/separating mechanism for the secondary transfer roller, this may result in an increase in cost. In order to reduce the cleaning time without such cost increases, it is necessary to reduce the amount of toner that becomes attached to the transport belt or the intermediate transfer belt.

### SUMMARY OF THE INVENTION

The disadvantages of the prior art are overcome by the present invention which, in one aspect, is a position error correcting apparatus including an image-forming condition determination pattern forming unit configured to form an image-forming condition determination pattern including plural unit patterns on an endless transport unit transported in a first direction, the plural unit patterns having different unit-area attached toner amounts and arranged in the first direction; a limit pattern detection unit configured to detect from the plural unit patterns a detection limit pattern having the minimum detectable unit-area attached toner amount; an image-forming condition calculate unit configured to calculate an image-forming condition for the detection limit pattern; a position error correction pattern forming unit configured to form a position error correction pattern on the endless transport unit in the first direction in accordance with the image-forming condition; and a position error correction unit configured to correct a position error of a toner image formed by plural image forming units on the endless transport unit, using the position error correction pattern, wherein the position error is corrected with respect to a second direction perpendicular to the first direction.

In another aspect, the present invention is a position error correcting method including forming an image-forming condition determination pattern on an endless transport unit transported in a first direction, the image-forming condition determination pattern including plural unit patterns having different unit-area attached toner amounts and arranged in the first direction; detecting a detection limit pattern having the minimum detectable unit-area attached toner amount from the unit patterns; calculating an image-forming condition of the detection limit pattern; forming a position error correction pattern on the endless transport unit in the first direction in accordance with the image-forming condition; and correcting a position error of a toner image formed on the endless transport unit by plural image forming units, using the position error correction pattern, wherein the position error is corrected with respect to a second direction perpendicular to the first direction.

In another aspect, the invention provides a computer-readable recording medium storing a program which, when executed by one or more processors of an information processing apparatus, carries out the above position error correcting method.

### BRIEF DESCRIPTION OF THE DRAWINGS

The above and further advantages of the invention may be better understood by referring to the following description in conjunction with the accompanying figures, described below.

FIG. 1 schematically illustrates the structure of a main portion of an image forming apparatus according to a first embodiment of the present invention;

FIG. 2 illustrates an internal structure of an exposing unit of the image forming apparatus;

FIG. 3 illustrates sensors (image detecting unit) and position error correction patterns;

FIG. 4 is an enlarged view of the sensors of FIG. 3;

FIG. 5 is a block diagram of a configuration for processing data in a position error correction process;

FIG. 6 illustrates image-forming condition determination patterns according to the first embodiment;

FIGS. 7A through 7C illustrate the principle of detection of the image-forming condition determination patterns;

FIGS. 8A and 8B illustrate a first method for determining a detection limit pattern;

FIGS. 9A and 9B illustrate a second method for determining a detection limit pattern;

FIG. 10 is a functional block diagram of a position error correcting apparatus according to the first embodiment;

FIG. 11 is a flowchart of a position error correction process;

FIG. 12 illustrates image-forming condition determination patterns according to a second embodiment of the present invention;

FIGS. 13A and 13B illustrate a third method for determining a detection limit pattern;

FIG. 14 illustrates an image-forming condition determination pattern according to a third embodiment of the present invention; and

FIG. 15 illustrates an image-forming condition determination pattern according to a fourth embodiment of the present invention.

### DETAILED DESCRIPTION OF THE PREFERRED EMBODIMENTS

Hereafter, various embodiments of the present invention are described with reference to the drawings, wherein like reference numerals designate identical or corresponding parts throughout the several views.

### First Embodiment

### Structure and Operation of Image Forming Apparatus

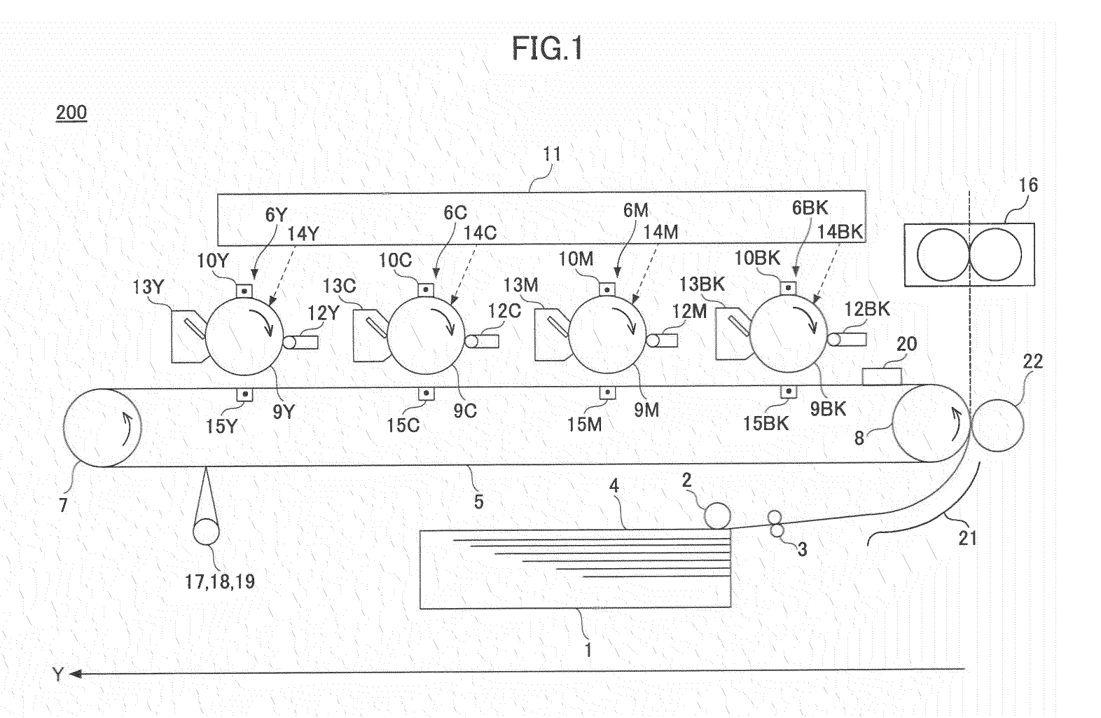

First, the structure and operation of an image forming apparatus 200 according to a first embodiment of the present invention are described. FIG. 1 is a schematic illustration of the structure of a main part of the image forming apparatus 200. The image forming apparatus 200 includes an intermediate transfer belt 5 (endless transport unit) along which image forming units (electrophotographic process units) 6BK, 6M, 6C, and 6Y for producing images of the colors of black, magenta, cyan, and yellow, respectively, are disposed. Thus, the image forming apparatus 200 is a so-called “tandem-type” image forming apparatus. The intermediate transfer belt 5 is an endless belt extended between a drive roller 7 and a driven roller 8. The drive roller 7 is driven by a drive motor (not shown) to move the intermediate transfer belt 5 in cooperation with the driven roller 8.

The plural image forming units 6BK, 6M, 6C, and 6Y are disposed along the intermediate transfer belt 5 in order from the upstream side. Although the plural image forming units 6BK, 6M, 6C, 6Y are configured to produce different colors of toner image, they may have the same internal structure.

The image forming unit 6BK includes a photosensitive drum 9BK as a photosensitive material body, around which there are disposed a charging unit 10BK, a developing unit 12BK, a photosensitive material cleaner (not shown), and a neutralizing unit 13BK. The exposing unit 11 is configured to emit laser light beams (exposing beams) 14BK, 14M, 14C, and 14Y corresponding to the colors of the images formed by the image forming units 6BK, 6M, 6C, and 6Y. The other image forming units 6M, 6C, and 6Y may have a similar structure to the image forming unit 6BK. Therefore, the constituent elements of the image forming units 6M, 6C, 6Y are designated by using M, C, and Y indicating the respective colors.

The toner images of the individual colors are transferred onto the intermediate transfer belt 5 by the transfer unit 15BK, 15M, 15C, and 15Y, at a position (“primary transfer position”) where the photosensitive drums 9BK, 9M, 9C, and 9Y contact the intermediate transfer belt 5. As a result, the images of the different colors are superposed on the intermediate transfer belt 5, forming a full-color image thereon.

During the image formation process, sheets 4 stocked in a paper-feed tray 1 are fed one by one from the top sheet. The sheet 4 is transported onto the intermediate transfer belt 5 by a sheet-feed roller 2 and a separating roller 3, and the full-color toner image is transferred onto the sheet 4 by a secondary transfer roller 22 at a position (“secondary transfer position”) where the intermediate transfer belt 5 contacts the sheet 4. The secondary transfer roller 22 is configured to press the sheet 4 against the intermediate transfer belt 5 so as to increase the transfer efficiency. The secondary transfer roller 22 is brought into close contact with the intermediate transfer belt 5 without using a contacting/separating mechanism.

When a position error correction pattern 30 is formed on or detected from the intermediate transfer belt 5 as will be described later, the position error correction pattern 30 passes the secondary transfer position before reaching the cleaning unit 20. As a result, the toner of the position error correction pattern 30 may become attached to the secondary transfer roller 22. The attached toner may stain the sheet 4, thus lowering image quality.

In order to eliminate such staining due to the attached toner, a bias voltage is applied to the secondary transfer roller 22 so as to collect the toner, in addition to using the cleaning mechanism employing a cleaning blade. Specifically, a bias voltage having the same polarity as the charge of the toner is applied to the secondary transfer roller 22 so as to cause the toner to become adsorbed on the intermediate transfer belt 5, and then the toner is scraped using the cleaning blade. When the toner has both positive and negative charges, the bias voltage may be caused to oscillate between positive and negative polarities. While the attachment of the toner to the secondary transfer roller 22 may be prevented by adding a contacting/separating mechanism to the secondary transfer roller 22, this results in increased cost. Thus, the first embodiment does not employ a contacting/separating mechanism.

In order to reduce the cleaning time without increase in cost, the amount of toner that becomes attached to the intermediate transfer belt 5 needs to be reduced. The image forming apparatus 200, in order to reduce the amount of toner that becomes attached to the intermediate transfer belt 5, includes a position error correcting apparatus 210. The function of the position error correcting apparatus 210 is described later.

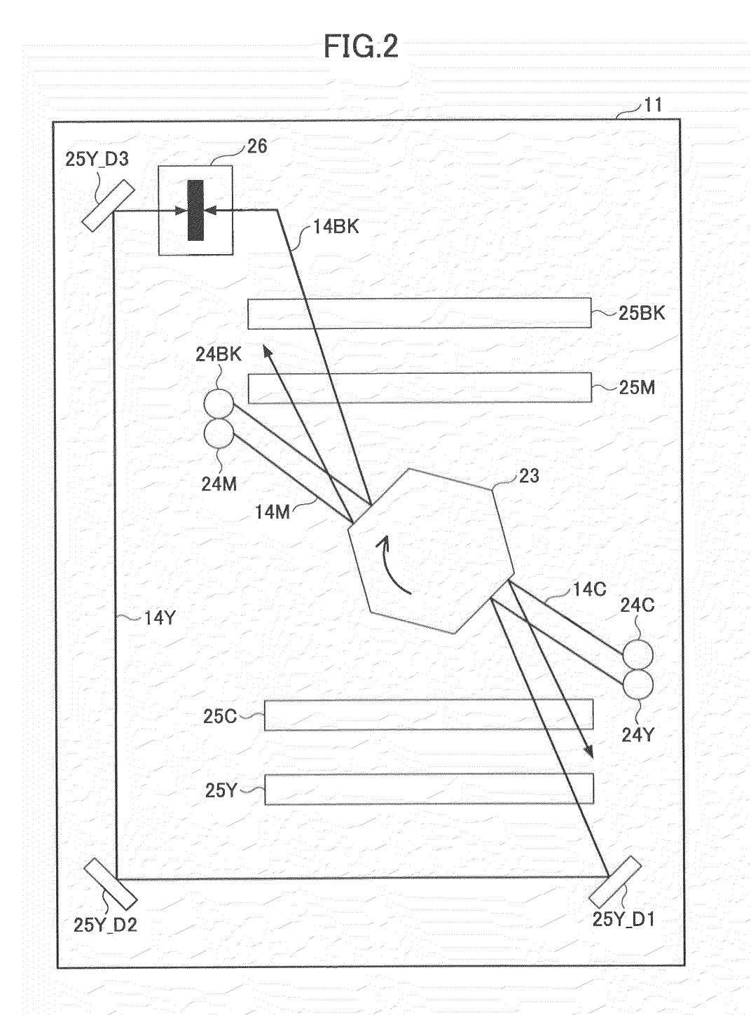

FIG. 2 is a schematic illustration of the internal structure of the exposing unit 11. As illustrated in FIG. 2, in the exposing unit 11, laser diodes 24BK, 24M, 24C, and 24Y (light sources) are configured to emit the laser light beams (exposing beams) 14BK, 14M, 14C, and 14Y, respectively, for the various colors. The emitted laser light beams have their optical paths adjusted by a reflecting mirror 23, travel through optical systems 25BK, 25M, 25C, and 25Y, and finally impinge on the surface of the photosensitive drums 9BK, 9M, 9C, and 9Y.

The reflecting mirror 23 is a polygon mirror configured to scan, as it rotates, the photosensitive drums with the exposing beams in a direction (“main-scan direction”) perpendicular to the direction (“sub-scan direction”) of transport of the sheet 4, by a distance corresponding to a line in the main-scan direction, using each of the six surfaces of the reflecting mirror 23. The sole reflecting mirror 23 is provided for the four laser diodes 24BK, 24M, 24C, and 24Y. The four photosensitive drums 9BK, 9M, 9C, and 9Y may be simultaneously exposed to the exposing beams 14BK, 14M, 14C, and 14Y by dividing the exposing beams to two groups of colors. Namely, one group may include the laser light beams 14BK and 14M, and the other may include the laser light beams 14C and 14Y, each scanning the opposite reflecting surfaces of the reflecting mirror 23. Optical systems 25BK, 25M, 25C, and 25Y may include an f-θ lens configured to make the reflected beams equally spaced, and a deflecting mirror configured to deflect laser light.

A synchronization detecting sensor 26 may be disposed outside an image area in the main-scan direction in order to detect the laser light beams 14BK and 14Y each time a line is scanned, so that the timing of the start of exposure can be adjusted during the image formation operation. Because the synchronization detecting sensor 26 is disposed on the side of the optical system 25BK, the laser light beam 14Y is incident on the synchronization detecting sensor 26 via the synchronization detecting folding mirrors 25Y_D1, 25Y_D2, and 25Y_D3. Because the write timing cannot be adjusted for the laser light beams 14M and 14C by the synchronization detecting sensor 26, the exposure start timing for magenta is aligned with the exposure start timing for black, and the cyan exposure start timing is aligned with the exposure start timing for yellow, thus aligning the image positions for the respective colors.

### Position Error Correction Pattern

Hereafter, the position error correction pattern 30 used for toner image position error correction is described. In the image forming apparatus 200, the toner images of the respective colors may not be superposed at a predetermined position due to various errors, resulting in a position between the various colors. The various errors may include an inter-axis distance error of the photosensitive drums 9BK, 9M, 9C, and 9Y; a parallelism error of the photosensitive drums 9BK, 9M, 9C, and 9Y; an installed-location error of the deflecting mirror in the exposing unit 11; and a write timing error during the writing of an electrostatic latent image onto the photosensitive drums 9BK, 9M, 9C, and 9Y. Such position errors among the colors may be caused by a skew, a registration error in the sub-scan direction, a magnification-ratio error in the main-scan direction, or a registration error in the main-scan direction, for example.

Thus, it is necessary to correct for the position error between the toner images of the various colors. For example, a position error correction is performed such that the image positions of the colors M, C, and Y are aligned with the BK image position. As illustrated in FIG. 1, sensors 17, 18, and 19 as image detecting units are provided opposite the intermediate transfer belt 5 downstream of the image forming unit 6Y. The sensors 17, 18, and 19, which may be supported on a common structure, such as a substrate, are disposed along the main-scan direction perpendicular to the direction Y of transport of the intermediate transfer belt 5 (sub-scan direction). The sensors 17, 18, and 19 may be configured to read a position error correction pattern or an image-forming condition determination pattern, as will be described below.

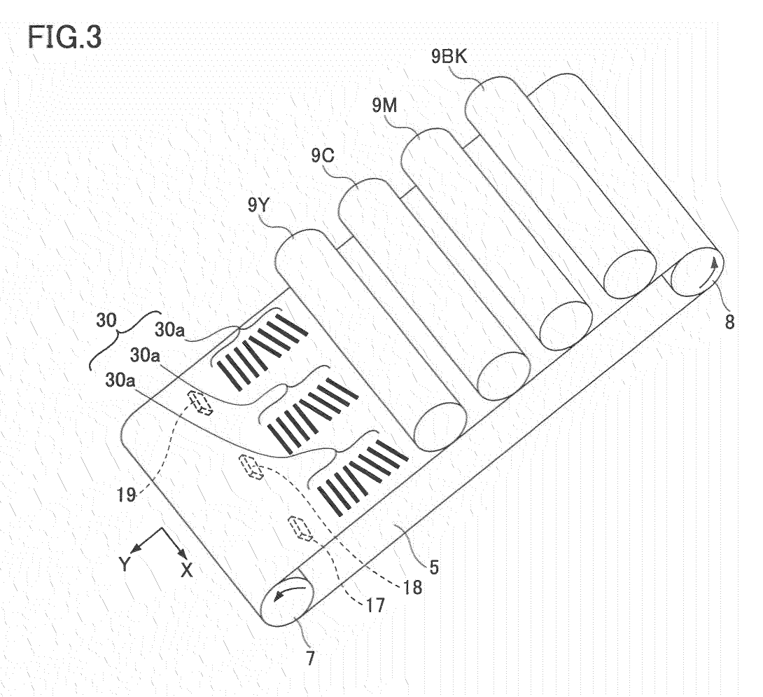

FIG. 3 is a perspective view of the image forming apparatus 200 of FIG. 1, illustrating the position error correction pattern 30. The position error correction pattern 30 includes patterns 30a which are formed at positions corresponding to the sensors 17, 18, and 19 in order to provide information required for calculating a position error amount for position error correction. The sensors 17, 18, and 19 are configured to detect a position error amount between the various colors. After the patterns 30a are detected by the sensors 17, 18, and 19, the patterns 30a (of toner) are removed from the intermediate transfer belt 5 by the cleaning unit 20. The cleaning unit 20 may include a cleaning blade pressed against the intermediate transfer belt 5 in order to scrape the toner attached onto the surface of the intermediate transfer belt 5.

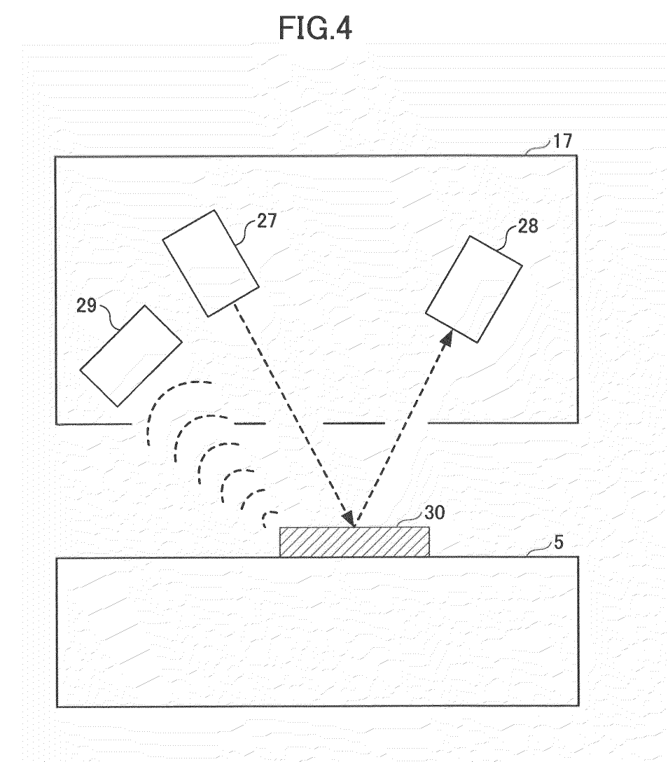

FIG. 4 is an enlarged view of the sensor 17, with reference to which the image detecting unit is described below. The sensors 18 and 19 may have the same structure as the sensor 17. The sensor 17 includes a light-emitting unit 27, a normal reflection reception unit 28, and a diffuse reflection reception unit 29. As will be described below, the diffuse reflection reception unit 29 may not be provided.

In the sensor 17, the light-emitting unit 27 emits a light beam with which the intermediate transfer belt 5 is irradiated. Reflected light from the intermediate transfer belt 5, which may include a normal-reflection component and a diffuse-reflection component, is received by the normal reflection reception unit 28. Thus, the sensor 17 has the function of detecting the position error correction pattern 30. The position error correction pattern 30 may be detected by using the normal reflection reception unit 28 alone. The diffuse reflection reception unit 29 may be used for detecting an attached toner amount adjusting pattern, which is conventionally used for adjusting the attached toner amount.

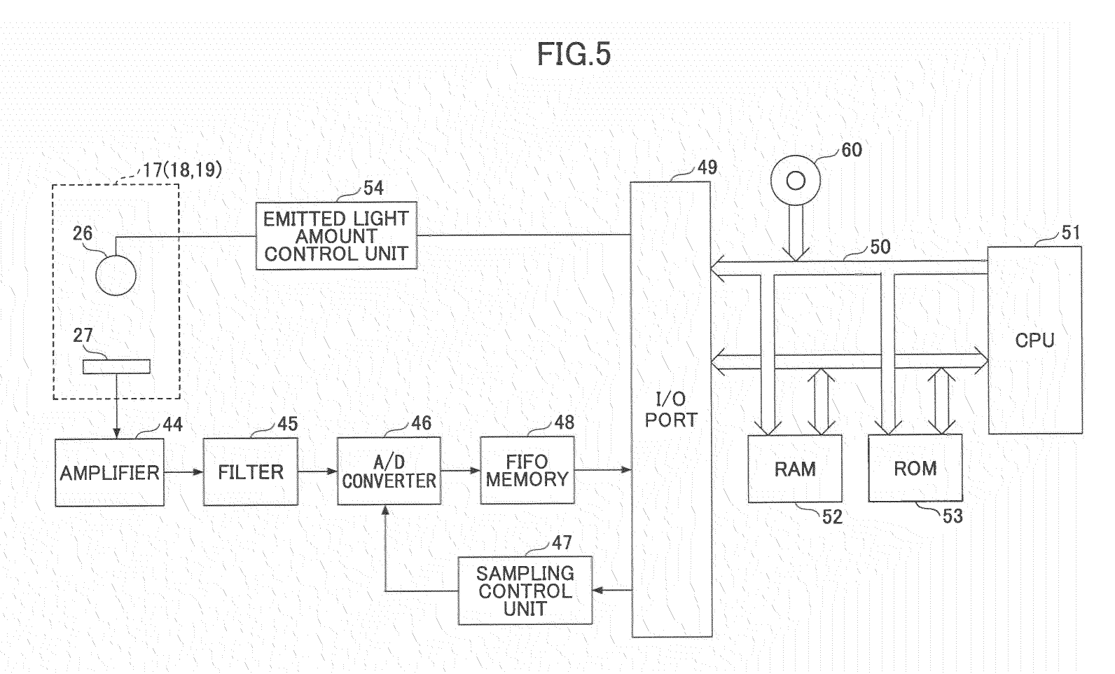

FIG. 5 is a diagram of a configuration for processing data for position error correction. Signals obtained from the normal reflection reception units 27 of the sensors 17, 18, and 19 are amplified by an amplifier 44. A filter 45 passes only a signal component for line detection, and the analog signal data is converted into digital data by an A/D conversion unit 46. Data sampling is controlled by a sampling control unit 47, and the sampled data is stored in a FIFO memory 48. After a set of pattern sequences of the position error correction pattern 30 is detected, the stored data is loaded via an I/O port 49 and a data bus 50 into a CPU 51 and a RAM 52. The CPU 51 performs a predetermined calculating process to determine the aforementioned various error amounts.

The ROM 53 may be configured to store various programs, such as a program for calculating the aforementioned various error amounts, and various other programs for controlling the image forming apparatus 200 and the position error correcting apparatus 210 according to the first embodiment. The CPU 51 is configured to monitor detection signals from the normal reflection reception units 28 of the sensors 17, 18, and 19 at appropriate timings. This is to ensure that, even if the intermediate transfer belt 5 or the light-emitting unit 27 is degraded, the CPU 51 can control the emitted-light amount control unit 54 so that reliable detection can be performed and a constant level of the light-reception signal from the normal reflection reception unit 28 can be obtained. Thus, the CPU 51 and the ROM 53 function as a control unit for controlling the overall operation of the image forming apparatus 200.

Thus, by forming and detecting the position error correction pattern 30, position error correction between the different colors is performed, so that a high-quality image can be output. However, even though the position error correction pattern 30 is removed from the intermediate transfer belt by the cleaning unit 20, some toner may remain on the intermediate transfer belt 5. Such residual toner may become attached to the printing sheet and stain it, thus lowering the image quality.

In order to eliminate such staining due to the residual toner, a bias voltage is applied to the cleaning unit 20 to collect the toner, in addition to utilizing the cleaning mechanism of the cleaning unit 20. Specifically, a bias voltage having the opposite polarity to the charge of the toner is applied to the cleaning unit 20 in order to remove the toner from the intermediate transfer belt 5. When the toner is both positively and negatively charged, the bias voltage may be oscillated between positive and negative polarities. However, such application of a bias voltage may result in an increase in the time for toner recovery, thereby increasing the error correction time and the user downtime.

In order to reduce the cleaning time, it is necessary to minimize the amount of toner that becomes attached to the intermediate transfer belt 5. Because the cleaning time is determined by the amount of toner attached per unit area (“unit-area attached toner amount”) times the line width in the sub-scan direction, the position error correction pattern 30 should be formed such that the product of the attached toner amount of the position error correction pattern 30 and its line width in the sub-scan direction becomes a minimum value that can be detected by the sensors. Thus, an appropriate image-forming condition for the position error correction pattern 30 is calculated by using an image-forming condition determination pattern 31 as described below. The line width in the main-scan direction does not affect the cleaning time because the toner in the main-scan direction is collected simultaneously.

### Image-Forming Condition Determination Pattern

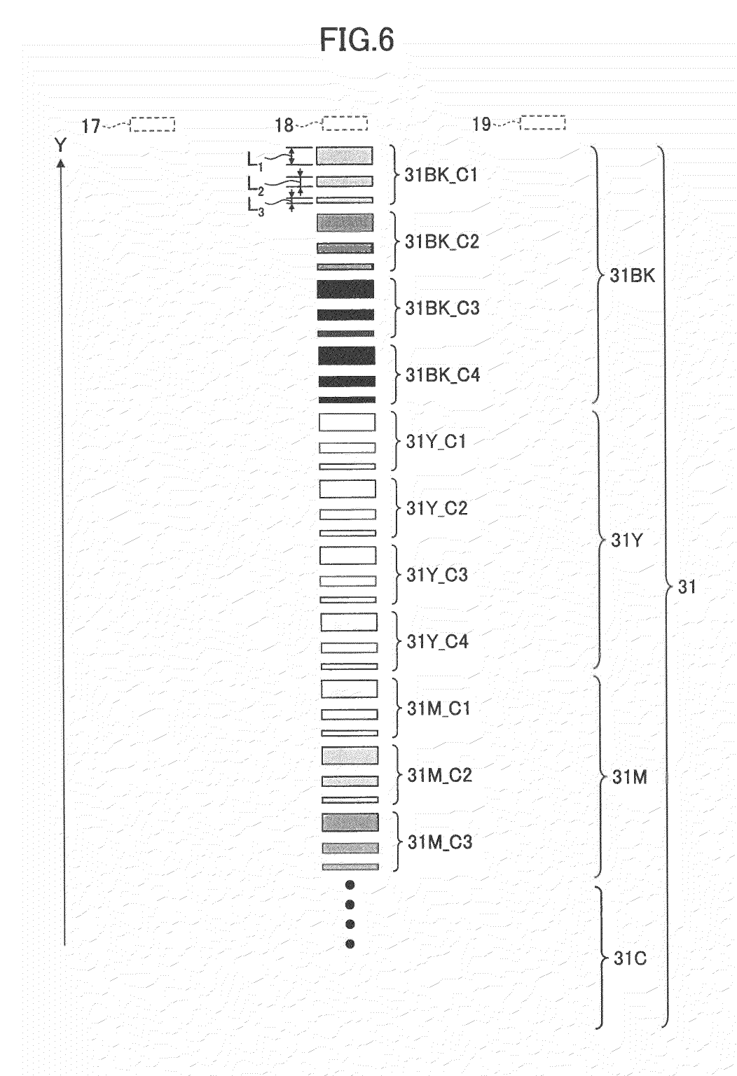

In the following, the image-forming condition determination pattern 31 is described with reference to FIG. 6. The image-forming condition determination pattern 31 is formed at a position corresponding to the sensor 18 disposed at substantially the center of an image in the main-scan direction. The image-forming condition determination pattern 31 includes a pattern 31BK for black, a pattern 31Y for yellow, a pattern 31M for magenta, and a pattern 31C for cyan, which are arranged substantially in parallel in the sub-scan direction Y.

The pattern 31BK includes unit patterns 31BK_C1, 31BK_C2, 31BK_C3, and 31BK_C which are arranged from the downstream side in the sub-scan direction Y (i.e., on the side of the sensor 18 at the top of the sheet), in order of increasing unit-area attached toner amounts. Each of the unit patterns 31BK_C1, 31BK_C2, 31BK_C3, and 31BK_C4 has the same unit-area attached toner amount and includes three patterns with different line widths L1, L2, and L3 in the sub-scan direction Y. In the present embodiment, each unit pattern includes a number n of patterns having the same unit-area attached toner amount (i.e., the same density) successively arranged in the sub-scan direction Y, where n≧1 (when n=1, there is only one unit pattern).

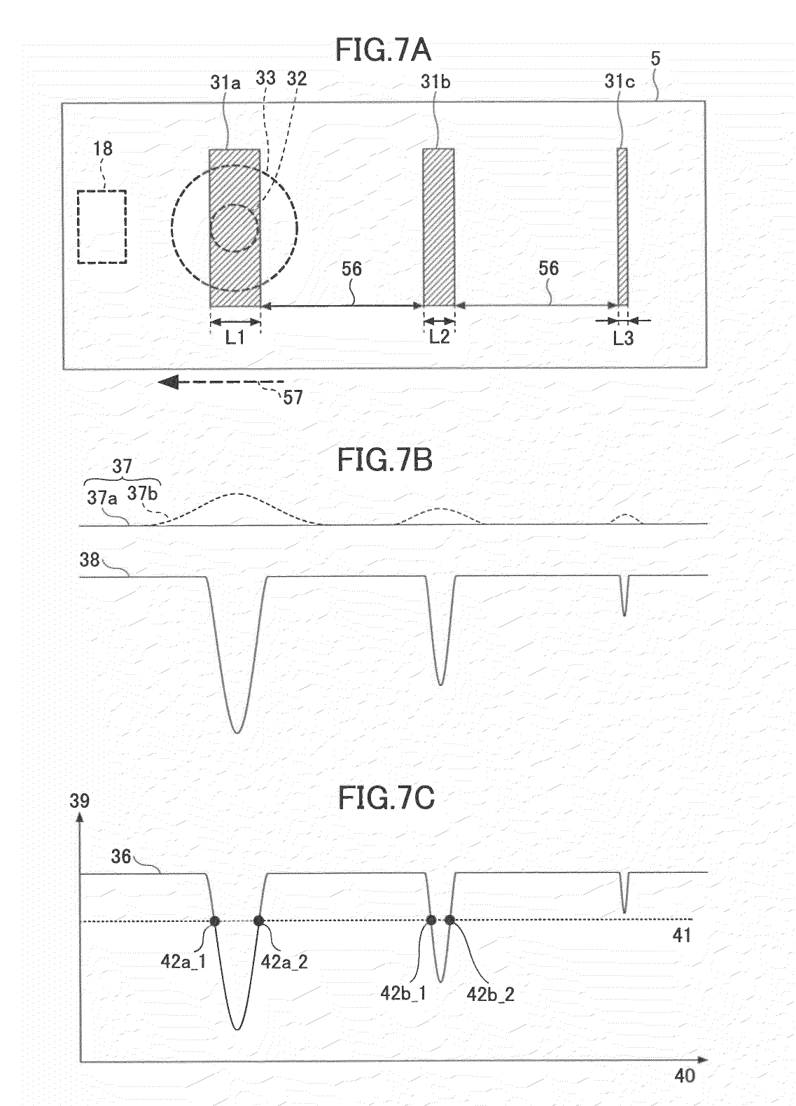

The patterns 31Y, 31M, and 31C have the same structure as the pattern 31BK and therefore their description is omitted. The maximum value of the line widths (L1-L3) of the pattern 31BK in the sub-scan direction may be 0.6 mm in diameter, which is substantially the same as the diameter of a spot 32 (see FIG. 7) received by the normal reflection reception unit 28. Namely, in FIG. 6, the line widths L1, L2, and L3 in the sub-scan direction are equal to or less than 0.6 mm.

The number of the unit patterns in the pattern 31BK, for example, is not limited to four. The number of the patterns with different line widths L1-L3 in the unit pattern 31BK_C1, for example, is also not limited to three.

By varying the development bias voltage and the light amount of the laser light 14 depending on the pattern, the attached toner amount of the four unit patterns of each of the patterns 31BK, 31Y, 31M, and 31C can be adjusted to a desired value. The image-forming condition determination pattern 31 may be detected by the sensor 18 having at least the normal reflection reception unit 28.

Preferably, the image-forming condition determination pattern 31 may be inclined with respect to the sub-scan direction Y by an angle of 45°. For example, the patterns in the unit pattern 31BK_C1 may be individually inclined by 45° with respect to the sub-scan direction Y. In this case, the maximum value of the line widths may be 0.6 mm. Further alternatively, the image-forming condition determination pattern 31 may include both a linear pattern and an inclined-line pattern. In this case, the smaller of the maximum value of the line widths of the linear pattern in the sub-scan direction Y and the maximum value of the line widths of the inclined-line pattern may be 0.6 mm.

### Principle of Detection of Image-Forming Condition Determination Pattern

In the following, the principle of detection of the image-forming condition determination pattern 31 is described with reference to FIGS. 7A and 7B. FIG. 7A is an enlarged view of one of the unit patterns 31BK_C1, 31BK_C2, 31BK_C3, and 31BK_C4 illustrated in FIG. 6. In FIG. 7A, the patterns 31a, 31b, and 31c are arranged in order of decreasing line width in a sheet transport direction 57 (sub-scan direction). The patterns 31a, 31b, and 31c are formed using the same development bias voltage and the same light amount of the laser light 14.

The maximum value of the line widths in the sub-scan direction Y may be the same as the diameter of the spot 32 of the irradiating light. The line width L2 of the pattern 31b, which is located upstream of the sheet transport direction 57 of the intermediate transfer belt 5 with respect to the line width L1, is smaller than the line width L1 of the pattern 31a. The line width L3 of the pattern 31c further upstream of the transport direction 57 is smaller than the line width L2 of the pattern 31b. The unit pattern sequence 31BK_C1, 31BK_C2, 31BK_C3, and 31BK_C4 for the pattern 31BK, for example, in the image-forming condition determination pattern 31 may be formed by varying the development bias voltage and the exposing beam light amount. Such unit pattern sequences are similarly formed for each of the rest of the four colors (M, Y, and C).

As in the case of the position error correction pattern 30, if two patterns are simultaneously irradiated with the irradiating light and diffuse light is reflected from the two patterns simultaneously, the patterns cannot be normally detected. In order to prevent this, the individual patterns in the image-forming condition determination pattern 31 are spaced by intervals 56 of 2 mm or more.

When the patterns 31a, 31b, and 31c illustrated in FIG. 7A are irradiated with light from the light-emitting unit 27 of the sensor 18, signals illustrated in FIG. 7B may be detected. In FIG. 7B, numeral 37 designates a diffuse-reflection component of the reflected light. Numeral 38 designates a normal-reflection component of the reflected light. FIG. 7B indicates that the diffuse-reflection component 37 is not reflected by the surface of the intermediate transfer belt 5 nor by the pattern 31BK (37a), but is reflected by the patterns 31M, 31C, and 31Y (37b). It also indicates that the normal-reflection component 38 is strongly reflected by the surface of the intermediate transfer belt 5 and is not reflected by the patterns in the image-forming condition determination pattern 31 regardless of the color. It can also be seen from FIG. 7B that the peak voltage levels of the diffuse-reflection component 37 and the normal-reflection component 38 outputted by the normal reflection reception unit 28 vary depending on the line width in the sub-scan direction Y (57).

FIG. 7C illustrates a signal outputted by the sensor 18 (normal reflection reception unit 28) upon detection of the unit pattern 31BK_C1, the vertical axis 39 indicating the output signal intensity of the normal reflection reception unit 28 and the horizontal axis 40 indicating time. In the case of the unit pattern 31BK_C1, no diffuse-reflection component is reflected (i.e., there is no 37b component), so that the output signal 36 is equal to the normal-reflection component 38. The sensor 18 detects pattern edges 42a_1, 42a_2, 42b_1, and 42b_2 where a threshold line 41 intersects the output signal 36, determining that it has detected the patterns 31a and 31b. The pattern 31c cannot be detected because there is no interesting of the threshold line 41 and the output signal 36.

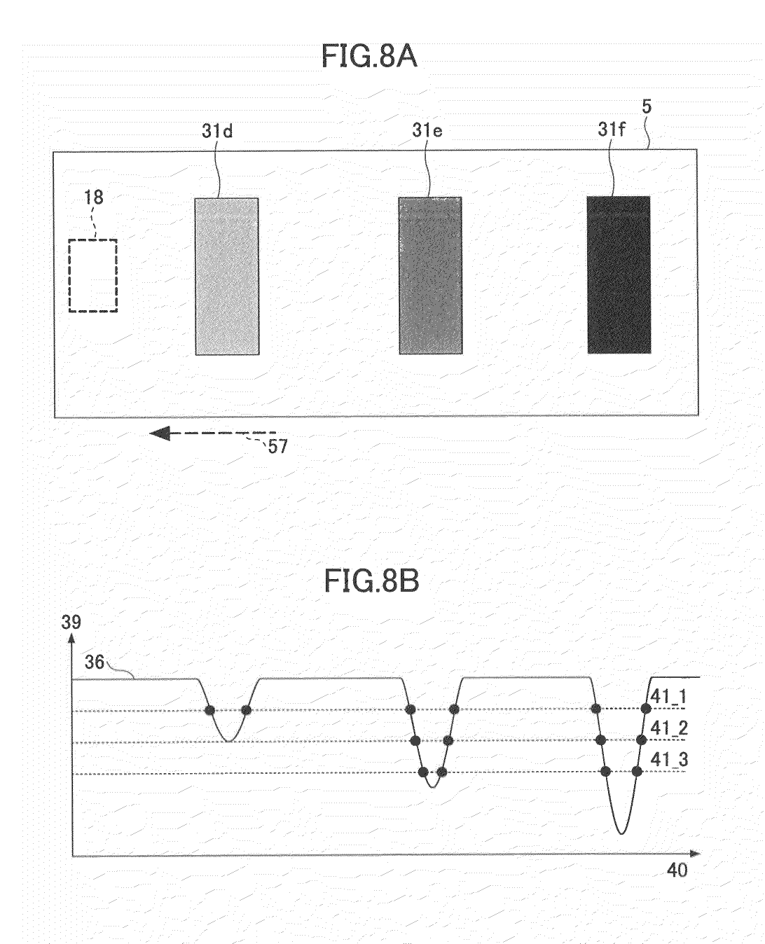

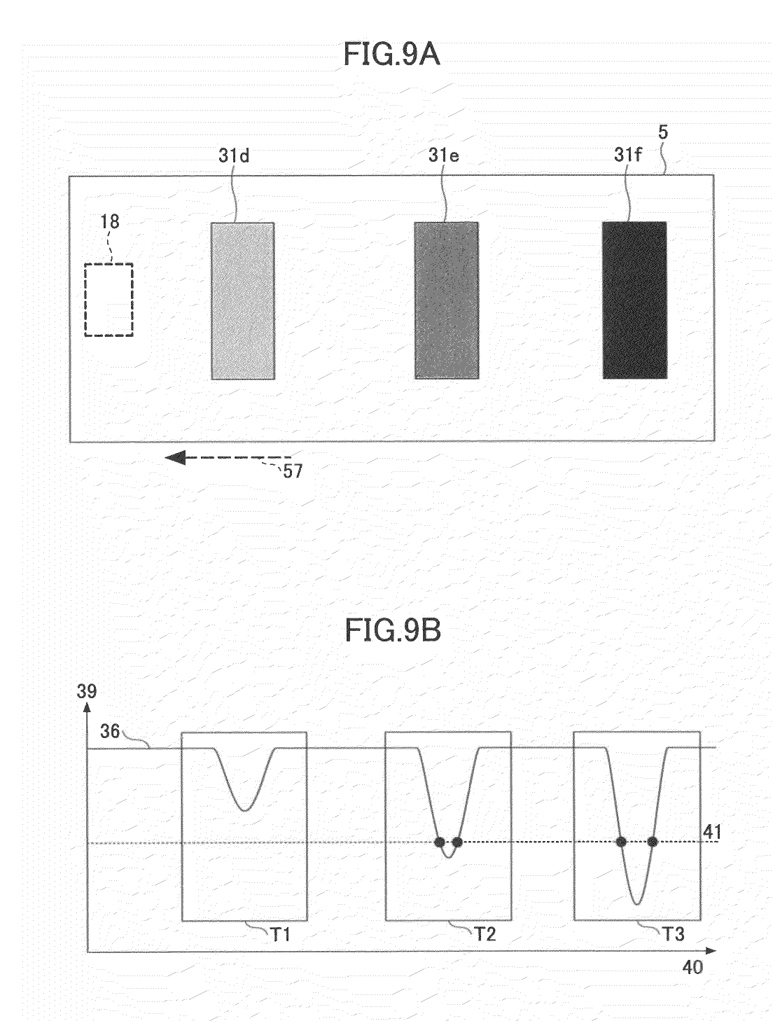

FIGS. 8A and 8B illustrate a first method for determining a detection limit pattern. In the following, the “detection limit pattern” refers to a pattern that is formed with the minimum required amount of toner for detection by the sensor 18. FIGS. 9A and 9B illustrate a second method for determining the detection limit pattern. While FIGS. 8A and 9A illustrate pattern sequences that include patterns 31d, 31e, and 31f with the same pattern width and different unit-area attached toner amounts, this is for the sake of description. Preferably, the same methods may be applied when the patterns have different widths as in the example of FIG. 6.

Referring to FIGS. 8A and 8B, the first method determines the detection limit pattern based on a plurality of threshold lines. Specifically, in the first method, three threshold lines 411, 412, and 41_3 are set for three different detection voltage levels. The threshold line 41_1 is a threshold line that can detect all patterns. The threshold line 41_2 and the threshold line 41_3 have lower detection voltage levels, with the threshold line 41_3 being set for a detection voltage level necessary for position error correction. While FIG. 8 illustrates the first method involving three threshold lines for determining the detection limit pattern, the first method may involve only two of the threshold lines 41_1 and 41_3.

Because the threshold line 41_3 is the threshold line (value) corresponding to the detection voltage level necessary for position error correction, a pattern initially detected with the threshold line 41_3 is considered the detection limit pattern. However, with the threshold line 41_3 alone, it cannot be determined whether the pattern initially detected by the threshold line 41_3 is the first, the second, or the third pattern, for example, in the case of FIGS. 8 and 9. Thus, it is determined whether the pattern initially detected by the threshold line 41_3 is the first, the second, or the third pattern by comparing the result of detection by the threshold line 41_1 and the result of detection by the threshold line 41_3.

Namely, because the threshold line 41_1 detects all of the patterns that are formed, it can be determined, whether the pattern detected by the threshold line 41_3 is the first, the second, or the third pattern by comparing the timing of detection of the patterns by the threshold lines 41_1 and 41_3. The image-forming condition of the pattern detected as the detection limit pattern is considered the image-forming condition for the detection limit pattern. The “image-forming condition” herein refers to parameters including a development bias voltage α, an exposing beam light amount β, and a line width γ, either individually or in combination.

With reference to FIG. 9, the second method for determining the detection limit pattern is described. The second method determines the detection limit pattern based on timing management. Specifically, the second method involves predicting times T1, T2, and T3 at which patterns pass immediately below the sensor 18, and performs the aforementioned pattern detection operation only at the predetermined times T1, T2, and T3. A sole threshold line 41 is set as the detection voltage level.

In the second method, an error may arise in the predicted time of passage of the patterns. In order to prevent such an error, a detection timing correction pattern may be disposed at the top of the image-forming condition determination pattern 31. By detecting the detection timing correction pattern, the time from the start of forming (exposing) the image-forming condition determination pattern to its arrival at the position of the sensor 18 is calculated. Then, the times T1, T2, and T3 may be adjusted by calculating and correcting an error between the measurement result and a theoretical value. After the formation of the image-forming condition determination pattern and upon reaching T1, pattern detection is performed using the threshold line 41. Thereafter, pattern detection is performed upon reaching T2 and T3. The pattern that is initially detected with the threshold line 41 is considered the detection limit pattern, which, in the example of FIG. 9, is the pattern detected at T2. Thus, it can be determined that the detection limit pattern is the second pattern, and therefore the image-forming condition of the second pattern is considered the image-forming condition of the detection limit pattern.

### Formation of Position Error Correction Pattern Using Image-Forming Condition Determination Pattern

In accordance with the present embodiment, the position error correcting apparatus 210 determines the limit condition (i.e., the detection limit pattern) of the minimum amount of toner for the position error correction pattern 30 that can be read by the sensor 18, by reading the image-forming condition determination pattern 31 using the sensor 18 and the like. As mentioned above, the toner amount is determined by the unit-area attached toner amount times the line width in the sub-scan direction. Then, based on the development bias voltage α, the exposing beam light amount β, and the sub-scan direction pattern line width γ corresponding to the determined detection limit pattern, the position error correction pattern 30 is formed for position error correction.

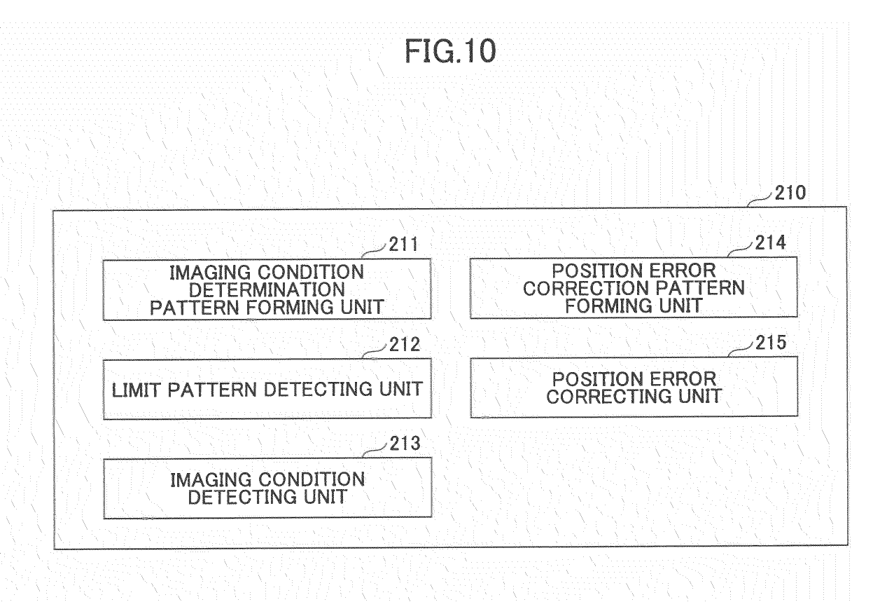

FIG. 10 is a functional block diagram of the position error correcting apparatus 210 according to the present embodiment. The position error correcting apparatus 210 includes an image-forming condition determination pattern forming unit 211, a limit pattern detection unit 212, an image-forming condition calculate unit 213, a position error correction pattern forming unit 214, and a position error correction unit 215.

The image-forming condition determination pattern forming unit 211 is configured to form the image-forming condition determination pattern 31, which includes the plural unit patterns with different unit-area attached toner amounts arranged in the sub-scan direction on the intermediate transfer belt 5, which is transported in the sub-scan direction. The image-forming condition determination pattern forming unit 211 may be realized by the image forming units 6BK, 6M, 6C, and 6Y, the CPU 51, and the ROM 53.

The limit pattern detection unit 212 is configured to detect from the plural unit patterns the detection limit pattern having the minimum detectable unit-area attached toner amount. The limit pattern detection unit 212 may be realized by the sensor 18, the CPU 51, and the ROM 53.

The image-forming condition calculate unit 213 is configured to calculate the image-forming condition of the detection limit pattern detected by the limit pattern detection unit 212. The “image-forming condition” includes the aforementioned development bias voltage α, exposing beam light amount β, and line width γ, either individually or in combination. The image-forming condition calculate unit 213 may be realized by the RAM 52 and the CPU 51.

The position error correction pattern forming unit 214 is configured to form the position error correction pattern 30 on the intermediate transfer belt 5 in accordance with the image-forming condition determined by the image-forming condition calculate unit 213. The position error correction pattern forming unit 214 may be realized by the image forming units 6BK, 6M, 6C, and 6Y, the CPU 51, and the ROM 53.

In the example of FIG. 7, the pattern 31b that is read upon detection of the edges 42b_1 and 42b 2 determines the limit condition (image-forming condition of the detection limit pattern) specifying the minimum amount of toner for the position error correction pattern 30 that can be read by the sensor 18 and the like. Thus, the position error correction pattern forming unit 213 forms the position error correction pattern 30 using the development bias voltage α, the exposing beam light amount β, and the pattern line width γ in the sub-scan direction that were used when the pattern 31b was formed. As a result, the position error correction pattern 30 can be formed with the minimum required amount of toner, so that the cleaning time and the user downtime can be reduced.

The position error correction unit 215 is configured to correct a position error of the toner images formed on the intermediate transfer belt 5 by the plural image forming units 6BK, 6M, 6C, and 6Y using the correction pattern 30, in the main-scan direction. The position error correction unit 215 may be realized by the CPU 51 and the ROM 53.

The aforementioned functions of the position error correcting apparatus 210 may be realized when a program recorded in the ROM 53 illustrated in FIG. 5 is read onto a main memory and executed by the CPU 51. However, some or all of these functions of the position error correcting apparatus 210 may be realized by hardware alone.

The program for realizing the aforementioned functions of the position error correcting apparatus 210 may be recorded in a recording medium 60, and the recorded program may be loaded onto the main memory for execution by the CPU 51, as illustrated in FIG. 5.

The position error correction unit 215 determines that an error occurred during detection limit pattern detection using the image-forming condition determination pattern 31 if the number of patterns in the position error correction pattern 30 detected during the position error correction operation is smaller than a predetermined number of patterns. Then, the position error correction pattern forming unit 214 may adjust the development bias voltage and the exposing beam light amount so that the position error correction pattern 30 has an attached toner amount that is equivalent to the attached toner amount during image output (thus changing the limit condition to a condition more favorable for the reading of the pattern by the sensor 17, for example). In this case, the maximum line width in the sub-scan direction may be set to be 0.6 mm which is the same as the diameter of the light spot 32 received by the normal reflection reception unit 28.

If the predetermined number of patterns cannot be detected in the position error correction pattern 30 during the position error correction operation that is carried out using the same attached toner amount as for image output, the position error correction unit 215 may determine that there is some abnormality not due to the detection limit pattern detection, and carry out the next position error correction without changing conditions.

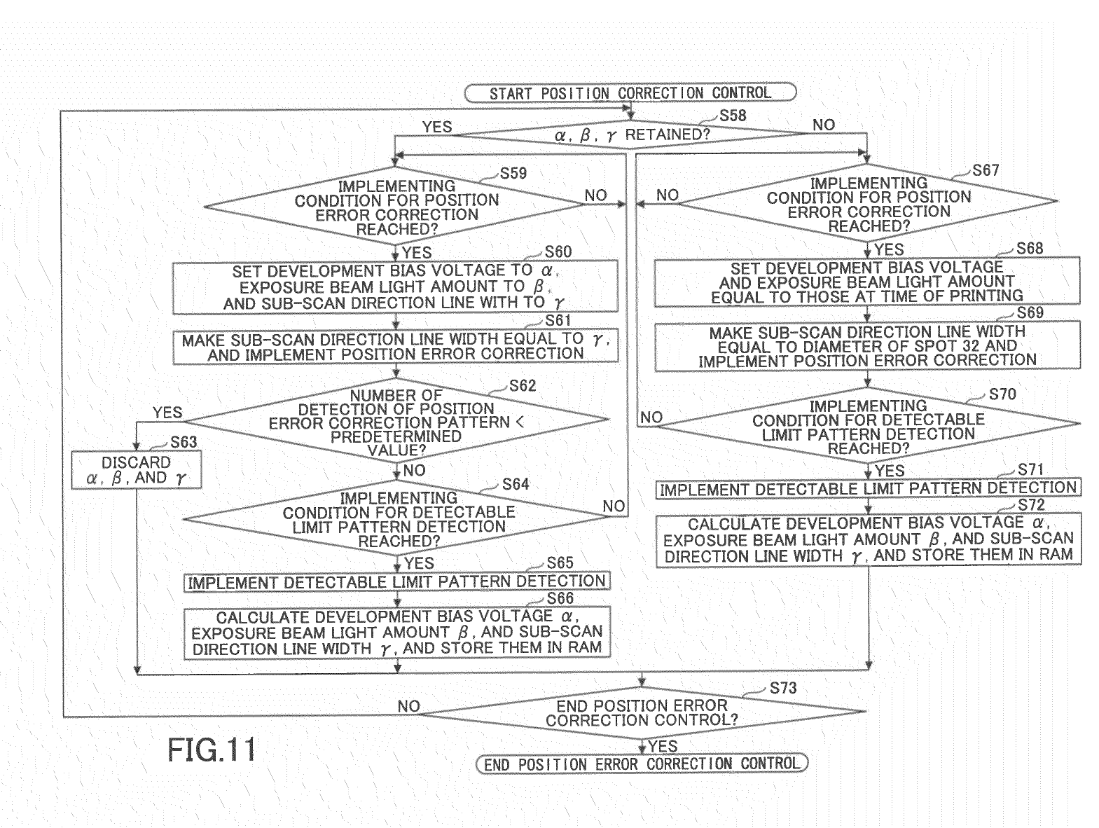

The above position error correction operation is described with reference to a flowchart illustrated in FIG. 11. First, in step 58, it is determined whether the data for forming the position error correction pattern 30, such as the development bias voltage α, the exposing beam light amount β, and the line width γ in the sub-scan direction, are retained in RAM. If so (“YES”), the routine proceeds to step 59. If not (“NO”), the routine proceeds to step 67.

In step 59, it is determined whether an implementing condition for position error correction is reached. If so (“YES”), the routine proceeds to step 60. The “implementing condition for position error correction” may refer to the continuous printing of 100 sheets, the continuous printing for 3 min, or the temperature within the exposing unit 11 reaching a predetermined temperature. In step 60, the development bias voltage is set to α, the exposing beam light amount is set to β, and the line width in the sub-scan direction is set to γ. In step 61, position error correction is implemented using the position error correction pattern 30 illustrated in FIG. 3.

In step 62, the number of patterns in the position error correction pattern 30 detected by the sensors 17, 18, and 19 is determined. If the number is smaller than a predetermined value (“YES”), the routine proceeds to step 63. If the number is equal to the predetermined value (“NO”), the routine proceeds to step 64. In step 63, the data of the development bias voltage α, the exposing beam light amount β, and the line width γ in the sub-scan direction stored in RAM are discarded, and then the routine proceeds to step 73. In step 64, it is determined whether an implementing condition for detection limit pattern detection using the image-forming condition determination pattern 31 is reached. If it is reached (“YES”), the routine proceeds to step 65; if not (“NO”), the routine proceeds to step 59. The “implementing condition for detection limit pattern detection using the image-forming condition determination pattern 31” may refer to the continuous printing of 200 sheets, or the temperature within the exposing unit 11 varying by 10° C. or more from the last detection limit pattern detection.

In step 65, detection limit pattern detection is implemented using the image-forming condition determination pattern 31 illustrated in FIG. 6. In step 66, based on the result of detection of the image-forming condition determination pattern 31 by the sensor 18, the development bias voltage α, the exposing beam light amount β, and the line width γ in the sub-scan direction corresponding to the detection limit pattern are calculated, and the calculated results are stored in RAM. In step 67, it is determined whether the implementing condition for position error correction is reached. If it is reached (“YES”), the routine proceeds to step 68.

In step 68, the development bias voltage and the exposing beam light amount of the position error correcting apparatus 210 are set to the same values as those during printing. In step 69, the line width in the sub-scan direction is made equal to the diameter of the spot 32, and position error correction is implemented using the position error correction pattern 30 illustrated in FIG. 3. In step 70, it is determined whether the implementing condition for detection limit pattern detection using the image-forming condition determination pattern 31 is reached. If it is reached (“YES”), the routine proceeds to step 71; if not (“NO”), the routine proceeds to step 67.

In step 71, detection limit pattern detection is implemented using the image-forming condition determination pattern 31 illustrated in FIG. 6. In step 72, based on the result of detection of the image-forming condition determination pattern 31 by the sensor 18, the development bias voltage α, the exposing beam light amount β, and the line width γ in the sub-scan direction corresponding to the detection limit pattern are calculated, and the calculated results are stored in RAM. In step 73, it is determined whether the position error correction control should be ended. If so (“YES”), the position error correction control ends. If not (“NO”), the routine proceeds to step 58.

Thus, in accordance with the first embodiment of the present invention, the image-forming condition determination pattern 31 is formed on the intermediate transfer belt 5. The image-forming condition determination pattern 31 includes plural unit patterns with different unit-area attached toner amounts that are arranged in the sub-scan direction, wherein each unit pattern includes plural patterns that are formed under the same image-forming condition and which have different line widths in the sub-scan direction. From among the plural unit patterns, the detection limit pattern having the minimum detectable unit-area attached toner amount and the minimum detectable line width is detected, and the image-forming condition of the detected detection limit pattern is calculated.

Further, the position error correction pattern 30 is formed on the intermediate transfer belt along the sub-scan direction in accordance with the calculated image-forming condition of the detection limit pattern, and a position error of toner images formed on the intermediate transfer belt 5 by the plural image forming units is corrected in the main-scan direction and the sub-scan direction. Thus, the position error correction pattern 30 can be formed with the minimum required toner amount, so that the amount of toner that becomes attached to the intermediate transfer belt 5 can be reduced. Further, because the position error correction pattern 30 can be formed with the minimum required toner amount, the cleaning time and therefore the user downtime can be reduced.

### Second Embodiment

The second embodiment differs from the first embodiment in that, instead of the image-forming condition determination pattern 31 used in the first embodiment, an image-forming condition determination pattern 81 is used.

### Image-Forming Condition Determination Pattern

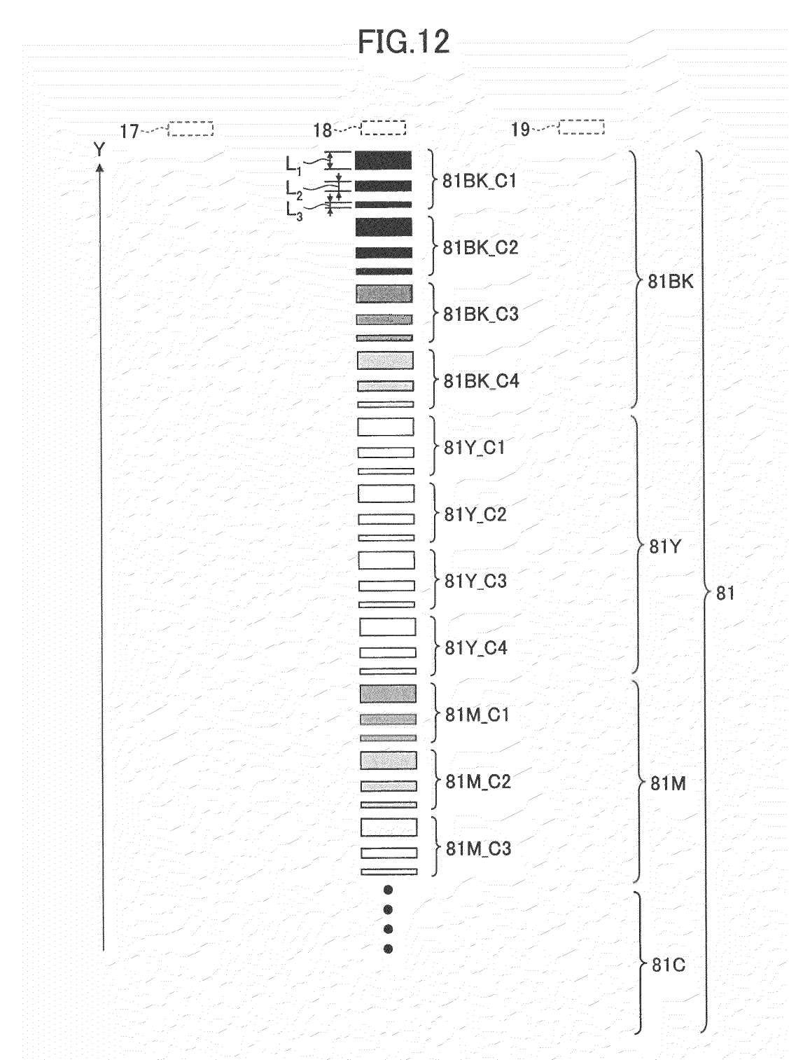

First, the image-forming condition determination pattern 81 is described with reference to FIG. 12. The image-forming condition determination pattern 81 is formed at a position corresponding to the sensor 18 disposed at substantially the center in the main-scan direction of an image, similarly to the image-forming condition determination pattern 31. Also similarly to the image-forming condition determination pattern 31, the image-forming condition determination pattern 81 includes patterns 81BK, 81Y, 81M, and 81C arranged substantially in parallel in the sub-scan direction Y.

In FIG. 12, the pattern 81BK includes unit patterns 81BK_C1, 81BK_C2, 81BK_C3, and 81BK_C4 which are arranged from the downstream side (on the side of the sensor 18 at the top of the sheet) in the sub-scan direction Y in order of decreasing unit-area attached toner amounts, in contrast to the first embodiment illustrated in FIG. 6 in which the unit patterns 31BK_C1, 31BK_C2, 31BK_C3, and 31BK_C are arranged from the downstream side in order of increasing unit-area attached toner amounts. As in the first embodiment illustrated in FIG. 6, each of the unit patterns 81BK_C1, 81BK_C2, 81BK_C3, and 81BK_C4 includes three patterns having the same unit-area attached toner amount and different line widths L1, L2, and L3 in the sub-scan direction Y.

The patterns 81Y, 81M, and 81C also include their respective unit patterns arranged in the same way as the unit patterns of the pattern 81BK. The conditions and the like for the line widths in the sub-scan direction Y are similar to those of the first embodiment.

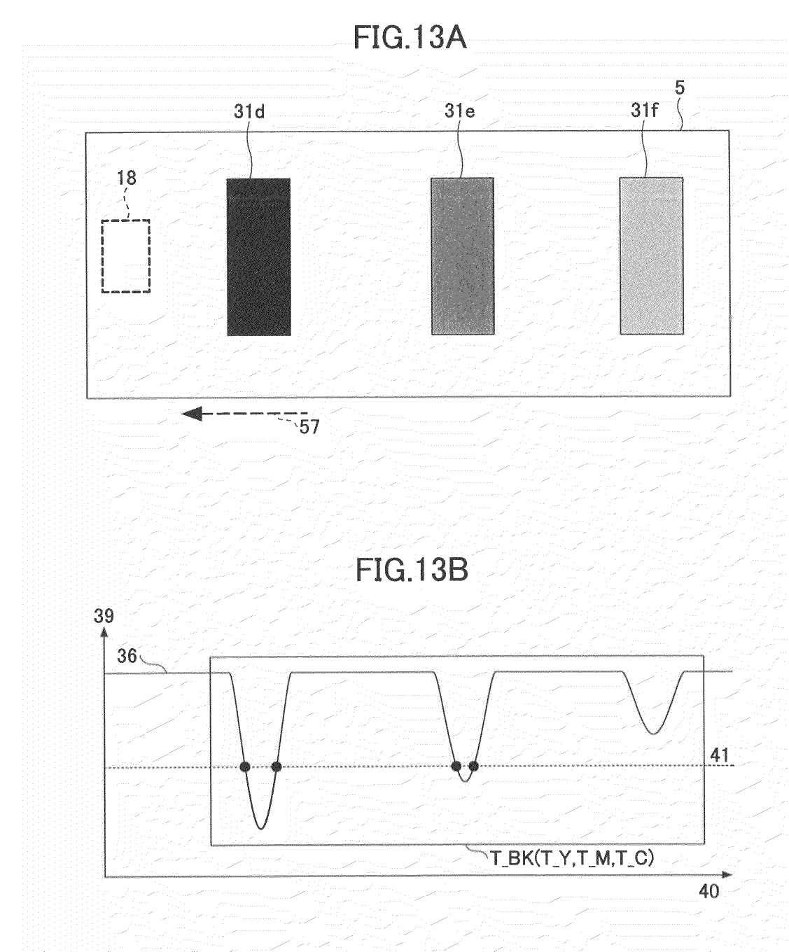

With reference to FIG. 13, a third method for determining the detection limit pattern is described. While FIG. 13 illustrates a pattern sequence including patterns 31d, 31e, and 31f having the same pattern width and different unit-area attached toner amounts, this is for the sake of ease of description. The same method may be applied when the pattern widths are different as in the example of FIG. 12.

The third method is used for detecting the pattern of FIG. 12 in which, in the pattern sequences of the respective colors, the unit patterns are arranged from the downstream side in the sub-scan direction Y in order of decreasing unit-area attached toner amounts (i.e., in order of decreasing density). A sole threshold line 41 is set as the detection voltage level. The third method also involves a partial timing management scheme.

Because the pattern sequences for the different colors in the image-forming condition determination pattern 81 are formed in order of decreasing unit-area attached toner amounts (i.e., density) from the downstream side in the sub-scan direction Y, the initial pattern (pattern 31d) detected with the threshold line 41 corresponds to the top pattern of the entire pattern sequence. Thus, it can be determined that the pattern detected last with the threshold line 41, i.e., the pattern 31e, is the detection limit pattern. Therefore, the development bias voltage α, the exposing beam light amount β, and the line width γ of the pattern 31e indicate the required condition.

However, merely counting the signals that have been read may not make it possible to detect the timing of starting the detection of the pattern 81Y following the detection of the pattern 81BK illustrated in FIG. 12, for example. Thus, in order to determine that a detected edge indicates either the pattern 81BK, 81Y, 81M, or 81C, a partial timing management scheme is implemented. Specifically, a time T_BK is set in which all of the patterns 81BK_C1 through 81BK_C4 of the pattern 81BK are detected. Similarly, times T_Y, T_M, and T C are set for the patterns 81Y, 81M, and 81C.

Thus, by forming the pattern sequence of each color in the image-forming condition determination pattern 81 in order of decreasing unit-area attached toner amounts (density) from the downstream side in the sub-scan direction Y, the need for plural threshold levels or a complicated timing management scheme can be eliminated. Further, because the patterns with higher densities exhibit greater degrees of drop in waveform, the patterns with higher densities can be more reliably detected. In the second embodiment, the process for formation of a position error correction pattern using the image-forming condition determination pattern 81 may be the same as in the first embodiment.

Thus, in accordance with the second embodiment, the following effect can be obtained in addition to the effects of the first embodiment. Namely, because the pattern sequence for each color in the image-forming condition determination pattern 81 is formed in order of decreasing unit-area attached toner amounts (density) from the downstream side in the sub-scan direction, the need for providing a plurality of threshold levels can be eliminated, so that the image-forming condition determination pattern can be detected by a simpler method.

In the first and the second embodiments, the unit patterns have three patterns with the same attached toner amount and different line widths L1, L2, and L3 in the sub-scan direction Y. However, the unit patterns may have a single pattern with a predetermined line width. In this case, while the optimum condition may not be detected for the width of the position error correction pattern in the sub-scan direction, the attached toner amount of the detection limit can be calculated.

### Third Embodiment

The third embodiment differs from the first embodiment in that, instead of the image-forming condition determination pattern 31, an image-forming condition determination pattern 101 is used.

### Image-Forming Condition Determination Pattern

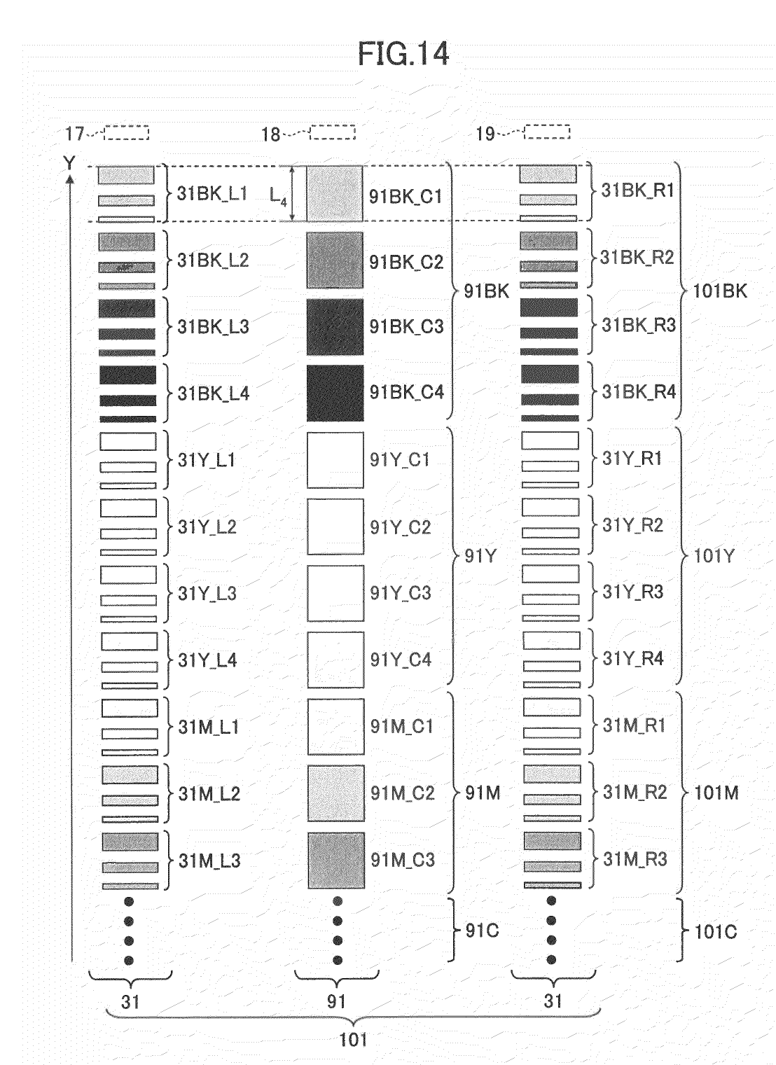

First, the image-forming condition determination pattern 101 is described with reference to FIG. 14. As illustrated, the image-forming condition determination pattern 101 includes a combination of the image-forming condition determination patterns 31 and an image-forming condition determination pattern 91. The image-forming condition determination pattern 91 is formed at a position corresponding to the sensor 18. The image-forming condition determination patterns 31 are formed at positions corresponding to the sensors 17 and 19.

In the example of FIG. 14, the image-forming condition determination pattern 31 formed at the position corresponding to the sensor 17 includes unit patterns 31BK_L1 through 31BK_L4, 31Y_L1 through 31Y_L4, 31M_L1 through 31M_L4, and 31C_L1 through 31C_L4. The image-forming condition determination pattern 31 formed at the position corresponding to the sensor 19 includes unit patterns 31BK_R1 through 31BK_R4, 31Y_R1 through 31Y_R4, 31M_R1 through 31M_R4, and 31C_R1 through 31C_R4.

The image-forming condition determination pattern 91 includes patterns 91BK, 91Y, 91M, and 91C arranged substantially in parallel in the sub-scan direction. The pattern 91BK includes unit patterns 91BK_C1, 91BK_C2, 91BK_C3, and 91BK_C4. These four unit patterns have the same line width L4 and are arranged from the downstream side in the sub-scan direction Y in order of increasing unit-area attached toner amounts. The patterns 91Y, 91M, and 91C have the same structure as the pattern 91BK.

The line width L4 of each unit pattern of the pattern 91BK in the sub-scan direction is equal to or greater than the diameter of the spot 33, which may be 2.0 mm (see FIG. 7A). The number of the unit patterns of the pattern 91BK, 91Y, 91M, and 91C is not limited to four.

By varying the development bias voltage and the light amount of the laser light 14 depending on the pattern, the unit-area attached toner amount of the four unit patterns of the patterns 91BK, 91Y, 91M, and 91C can be adjusted to a desired value. The image-forming condition determination pattern 91 may be detected by the sensor 18 including the normal reflection reception unit 28 and the diffuse reflection reception unit 29.

The image-forming condition determination patterns 31 are formed under the same conditions of the development bias voltage and the light amount of the laser light 14 as the conditions for the image-forming condition determination pattern 91 disposed side by side in the main-scan direction. The image-forming condition determination patterns 31 may include a linear pattern in which a plurality of patterns are formed with the same development bias voltage and the same light amount of the laser light 14 while their line widths are varied in the sub-scan direction. Namely, in the image-forming condition determination patterns 31 and 91, the density (unit-area attached toner amount) of the patterns in the main-scan direction is the same. For example, the three patterns in the unit pattern 31BK_L1, the unit pattern 31BK_C1, and the three patterns in the unit pattern 31BK_R1 have the same density (unit-area attached toner amount).

The image-formed positions of the image-forming condition determination patterns 31 in the sub-scan direction are always within the image-formed position of the image-forming condition determination pattern 91 in the sub-scan direction. For example, the three patterns in the unit pattern 31BK_L1 and the three patterns in the unit pattern 31BK_R1 are always formed within a range corresponding to L4 in the sub-scan direction in which the unit pattern 91BK_C1 is formed (see the broken lines in FIG. 14).

The image-forming condition determination pattern 91 is an attached toner amount adjusting pattern that is conventionally used for adjusting the attached toner amount. In the third embodiment, the image-forming condition determination pattern 91 is not used for calculating the image-forming condition of the position error correction pattern. Namely, the image-forming condition determination pattern 91 is used only for adjusting the attached toner amount as is conventionally done.

In the third embodiment, the image-forming condition determination patterns 31 are formed on either side of the attached toner amount adjusting pattern (image-forming condition determination pattern 91). The image-forming condition determination patterns 31 are read by the sensors 17 and 19, which may include at least the normal reflection reception unit, in order to calculate the image-forming condition for the position error correction pattern.

The image-forming condition determination pattern 31 may be inclined with respect to the sub-scan direction by an angle of 45°. In this case, the maximum value of the line widths may be 0.6 mm. Further, the image-forming condition determination pattern 31 may include both a linear pattern and an inclined-line pattern. In this case, the smaller of the maximum value of the line widths of the linear pattern in the sub-scan direction and the maximum value of the line widths of the inclined-line pattern may be 0.6 mm.

### Principle of Detection of the Image-Forming Condition Determination Pattern

As described above, the sensors 17 and 19 are used for detecting the image-forming condition determination pattern 101. In order to read the image-forming condition determination patterns 31 in the image-forming condition determination pattern 101 using the sensors 17 and 19, the first or the second method described with reference to the first embodiment may be used.

In the third embodiment, the process for forming the position error correction pattern using the image-forming condition determination patterns may be the same as in the first embodiment. However, in the third embodiment, while the image-forming condition determination patterns 31 are formed on either side of the attached toner amount adjusting pattern (image-forming condition determination pattern 91), because the patterns in the main-scan direction are formed at once (i.e., the image-forming condition determination patterns 31 and 91 can be simultaneously formed), the image-forming condition determination pattern 31 can be formed within the same time as the time in which the image-forming condition determination pattern 91 is formed. Namely, because the image-forming condition determination pattern 91 is conventionally formed for adjusting the attached toner amount, the image-forming condition determination pattern 31 for calculating the image-forming condition of the position error correction pattern can be formed without increasing the user downtime.

Thus, in accordance with the third embodiment, the following effect can be obtained in addition to the effects provided by the first embodiment. Namely, because the image-forming condition determination patterns 31 can be formed on either side of the attached toner amount adjusting pattern 91 with the same density and within the same range, the image-forming condition determination patterns 31 can be formed without increasing the user downtime.

### Fourth Embodiment

The fourth embodiment differs from the first embodiment in that, instead of the image-forming condition determination pattern 31, an image-forming condition determination pattern 111 is used.

### Image-Forming Condition Determination Pattern

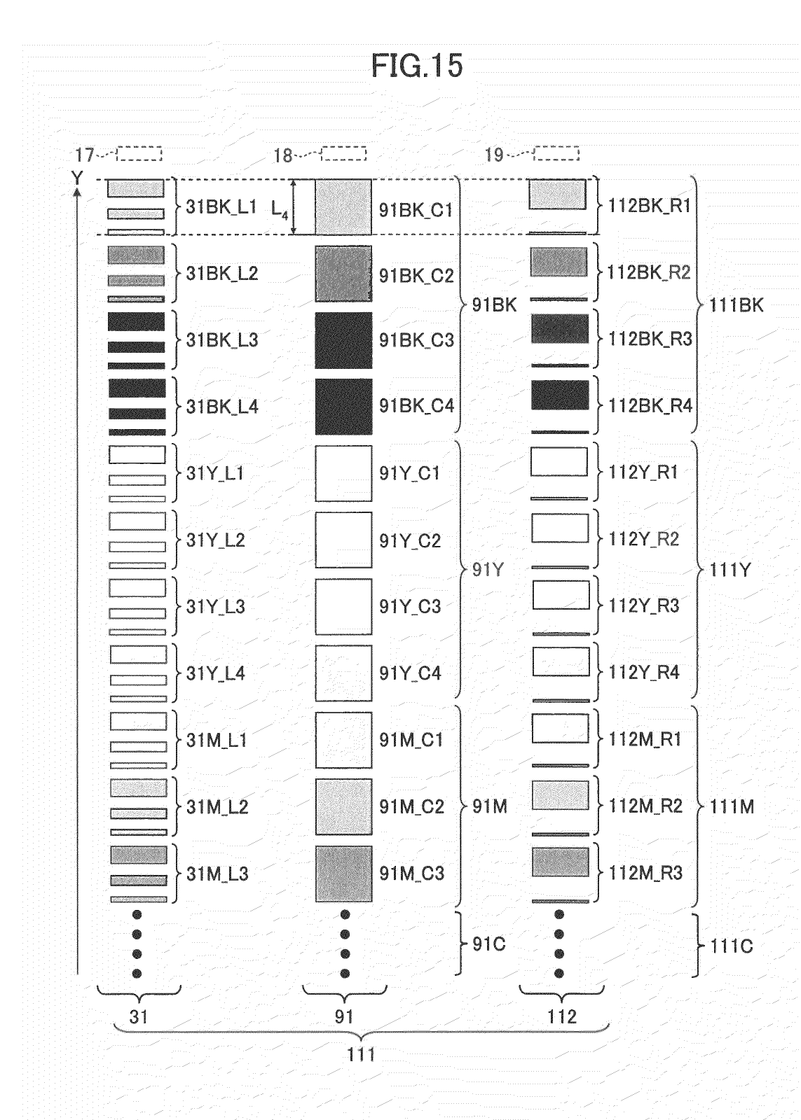

First the image-forming condition determination pattern 111 is described with reference to FIG. 15. The image-forming condition determination pattern 111 includes a combination of the image-forming condition determination pattern 31, the image-forming condition determination pattern 91, and an image-forming condition determination pattern 112.

In the image-forming condition determination pattern 111, the same pattern as the image-forming condition determination pattern 31 illustrated in FIG. 6 is formed at a position corresponding to the sensor 17. The image-forming condition determination pattern 31 includes unit patterns 31BK_L1 through 31BK_L4, 31Y_L1 through 31Y_L4, 31M_L1 through 31M_L4, and 31C_L1 through 31C_L4.

The image-forming condition determination pattern 91 is formed at a position corresponding to the sensor 18. The image-forming condition determination pattern 112 is formed at a position corresponding to the sensor 19. The image-forming condition determination patterns 31 and 112 are formed under the same conditions of the development bias voltage and the light amount of the laser light 14 as those for the image-forming condition determination pattern 91 disposed side by side in the main-scan direction. The image-forming condition determination patterns 31 and 112 are linear patterns including a plurality of patterns that are formed with the same development bias voltage and the same light amount of the laser light 14 while their line widths are varied in the sub-scan direction. However, the image-forming condition determination patterns 31 and 112 may have different combinations of line widths.

Specifically, in the image-forming condition determination patterns 31, 91, and 112, the density (unit-area attached toner amount) of the patterns arranged in the main-scan direction is the same. For example, the three patterns in the unit pattern 31BK_L1, the unit pattern 31BK_C1, and the two patters in the unit pattern 112BK_R1 have the same density (unit-area attached toner amount).

The image-formed positions of the image-forming condition determination patterns 31 and 112 in the sub-scan direction are always within the range of the image-formed position of the image-forming condition determination pattern 91 in the sub-scan direction. For example, the three patterns in the unit pattern 31BK_L1 and the two patterns in the unit pattern 112BK_R1 are always formed within a range corresponding to L4 in the sub-scan direction Y in which the unit pattern 91BK_C1 is formed (see the broken lines in FIG. 15).

In the sub-scan direction Y, the image-forming condition determination patterns 31 and 112 have different combinations of line widths. Thus, the line width can be varied in a greater range than is possible with the image-forming condition determination pattern 101 of FIG. 14.

The image-forming condition determination pattern 91 is an attached toner amount adjusting pattern that is conventionally used for adjusting the attached toner amount. In the fourth embodiment, the image-forming condition determination pattern 91 is not used for calculating the image-forming condition of the position error correction pattern. Namely, the image-forming condition determination pattern 91 is used solely for adjusting the attached toner amount as is conventionally done.

In the fourth embodiment, the image-forming condition determination patterns 31 and 112, which are formed on either side of the image-forming condition determination pattern 91, are read by the sensors 17 and 19, which may include at least the normal reflection reception unit, in order to calculate the image-forming condition of the position error correction pattern.

The maximum value of the line widths in the sub-scan direction may be substantially the same as the spot 32 of the light received by the normal reflection reception unit 28, which may be 0.6 mm. The image-forming condition determination patterns 31 and 112 may be inclined with respect to the sub-scan direction by 45°. In this case, the maximum value of the line widths may be 0.6 mm. Further, the image-forming condition determination patterns 31 and 112 may include both a linear pattern and an inclined-line pattern. In this case, the smaller of the maximum value of the line widths of the linear pattern in the sub-scan direction and the maximum value of the line widths of the inclined-line pattern may be 0.6 mm.

### Principle of Detection of Image-Forming Condition Determination Pattern

As described above, the sensors 17 and 19 may be used for detecting the image-forming condition determination patterns 31 and 112. In order to read the image-forming condition determination patterns 31 and 112 of the image-forming condition determination pattern 111 using the sensors 17 and 19, the first or the second method described with reference to the first embodiment may be used. The pattern read by the sensor 17 or 19 that has the smallest line width is the detection limit pattern.

In the fourth embodiment, the process for forming the position error correction pattern using the image-forming condition determination pattern may be the same as that of the first embodiment. However, in the fourth embodiment, while the image-forming condition determination patterns 31 and 112 are formed on either side of the image-forming condition determination pattern 91, because the patterns in the main-scan direction are formed at once (i.e., the image-forming condition determination patterns 31, 91, and 112 can be simultaneously formed), the image-forming condition determination patterns 31 and 112 can be formed within the same time as the time in which the image-forming condition determination pattern 91 is conventionally formed. Namely, because the image-forming condition determination pattern 91 is conventionally formed for adjusting the attached toner amount, the image-forming condition determination patterns 31 and 112 for calculating the image-forming condition of the position error correction pattern can be formed without increasing the user downtime.

Thus, in accordance with the fourth embodiment, the following effect in addition to the effects of the first embodiment can be provided. Namely, by forming the image-forming condition determination patterns 31 and 112 for calculating the image-forming condition of the position error correction pattern on either side of the attached toner amount adjusting pattern 91 with the same density and in the same range, the image-forming condition determination patterns 31 and 112 for calculating the image-forming condition of the position error correction pattern can be formed without increasing the user downtime. Further, compared to the image-forming condition determination pattern illustrated in FIG. 14, the range in which the line width can be varied can be increased.

While the foregoing embodiments have been described with reference to an image forming apparatus having the intermediate transfer belt, the present invention may be embodied in an image forming apparatus of a direct transfer type. In this case, a transport belt may be used instead of the intermediate transfer belt.

Although this invention has been described in detail with reference to certain embodiments, variations and modifications exist within the scope and spirit of the invention as described and defined in the following claims.

The present application is based on the Japanese Priority Applications No. 2009-066452 filed Mar. 18, 2009 and No. 2010-050375 filed Mar. 8, 2010, the entire contents of which are hereby incorporated by reference.

What is claimed is:

1. A position error correcting apparatus comprising:
an image-forming condition determination pattern forming unit configured to form an image-forming condition determination pattern including plural unit patterns on an endless transport unit transported in a first direction, the plural unit patterns having different unit-area attached toner amounts and arranged in the first direction;
a limit pattern detection unit configured to detect from the plural unit patterns a detection limit pattern having the minimum detectable unit-area attached toner amount;
an image-forming condition calculate unit configured to calculate an image-forming condition for the detection limit pattern;
a position error correction pattern forming unit configured to form a position error correction pattern on the endless transport unit in the first direction in accordance with the image-forming condition; and
a position error correction unit configured to correct a position error of a toner image formed by plural image forming units on the endless transport unit, using the position error correction pattern, wherein the position error is corrected with respect to a second direction perpendicular to the first direction.

2. The position error correcting apparatus according to claim 1, wherein each of the plural unit patterns includes plural patterns formed under the same image-forming condition and having different line widths in the first direction, and
wherein the limit pattern detection unit is configured to detect from the plural patterns a detection limit pattern having the minimum detectable unit-area attached toner amount and the minimum line width.

3. The position error correcting apparatus according to claim 1, wherein the image-forming condition determination pattern includes plural pattern sequences arranged in the second direction.

4. The position error correcting apparatus according to claim 3, wherein the plural pattern sequences include a first pattern sequence and a second pattern sequence, wherein the first pattern sequence includes plural unit patterns having the same line width in the first direction and arranged in the first direction, and the second pattern sequence includes a unit pattern which includes plural patterns formed under the same image-forming condition and arranged in the first direction, the plural patterns having different line widths in the first direction, and
wherein the limit pattern detection unit is configured to detect from the plural patterns of the second pattern sequence a detection limit pattern having the minimum detectable unit-area attached toner amount and the minimum line width.

5. The position error correcting apparatus according to claim 3, wherein the plural pattern sequences include a first pattern sequence, a second pattern sequence, and a third pattern sequence,
the first pattern sequence including plural unit patterns having the same line width in the first direction and arranged in the first direction,
the second pattern sequence including a unit pattern having plural patterns formed under the same image-forming condition and arranged in the first direction, the plural patterns having different line widths in the first direction,
the third pattern sequence including a unit pattern having plural patterns formed under the same image-forming condition and arranged in the first direction, the plural patterns having a different line width from the line width of the second pattern sequence in the first direction, and
wherein the limit pattern detection unit is configured to detect, from the plural patterns of the second and third pattern sequences, a detection limit pattern having the minimum detectable unit-area attached toner amount and the minimum line width.

6. The position error correcting apparatus according to claim 4, wherein the first pattern sequence includes an attached toner amount adjusting pattern for adjusting an attached toner amount.

7. A position error correcting method comprising:
forming an image-forming condition determination pattern on an endless transport unit transported in a first direction, the image-forming condition determination pattern including plural unit patterns having different unit-area attached toner amounts and arranged in the first direction;
detecting a detection limit pattern having the minimum detectable unit-area attached toner amount from the unit patterns;
calculating an image-forming condition of the detection limit pattern;
forming a position error correction pattern on the endless transport unit in the first direction in accordance with the image-forming condition; and
correcting a position error of a toner image formed on the endless transport unit by plural image forming units, using the position error correction pattern, wherein the position error is corrected with respect to a second direction perpendicular to the first direction.

8. The position error correcting method according to claim 7, wherein the step of forming the image-forming condition determination pattern includes forming a unit pattern including plural patterns formed under the same image-forming condition and having different line widths in the first direction; and
the step of detecting the limit pattern includes detecting from the plural patterns a detection limit pattern having the minimum detectable unit-area attached toner amount and the minimum line width.

9. The position error correcting method according to claim 7, wherein the step of forming the image-forming condition determination pattern includes forming plural pattern sequences arranged in the second direction.

10. The position error correcting method according to claim 9, wherein the step of forming the image-forming condition determination pattern includes forming a first pattern sequence and a second pattern sequence, wherein
the first pattern sequence includes plural unit patterns having the same line width in the first direction and arranged in the first direction, and
the second pattern sequence includes a unit pattern which includes plural patterns formed under the same image-forming condition and arranged in the first direction, the plural patterns having different line widths in the first direction, and
the step of detecting the limit pattern includes detecting from the plural patterns of the second pattern sequence a detection limit pattern having the minimum detectable unit-area attached toner amount and the minimum line width.

11. The position error correcting method according to claim 10, wherein the step of forming the image-forming condition determination pattern includes forming a first pattern sequence, a second pattern sequence, and a third pattern sequence,
the first pattern sequence including plural unit patterns having the same line width in the first direction and arranged in the first direction,
the second pattern sequence including a unit pattern having plural patterns formed under the same image-forming condition and arranged in the first direction, the plural patterns having different line widths in the first direction,
the third pattern sequence including a unit pattern having plural patterns formed under the same image-forming condition and arranged in the first direction, the plural patterns having a different line width from the line width of the second pattern sequence in the first direction, and
wherein the step of detecting the limit pattern includes detecting, from the plural patterns of the second and third pattern sequences, a detection limit pattern having the minimum detectable unit-area attached toner amount and the minimum line width.

12. The position error correcting method according to claim 10, wherein the first pattern sequence includes an attached toner amount adjusting pattern for adjusting an attached toner amount.

13. An image forming apparatus comprising the position error correcting apparatus according to claim 1.

14. A computer-readable recording medium storing a program which, when executed by one or more processors of an information processing apparatus, carries out a position error correcting method comprising:
forming an image-forming condition determination pattern on an endless transport unit transported in a first direction, the image-forming condition determination pattern including plural unit patterns having different unit-area attached toner amounts and arranged in the first direction;
detecting a detection limit pattern having the minimum detectable unit-area attached toner amount from the unit patterns;
calculating an image-forming condition of the detection limit pattern;
forming a position error correction pattern on the endless transport unit in the first direction in accordance with the image-forming condition; and
correcting a position error of a toner image formed on the endless transport unit by plural image forming units, using the position error correction pattern, wherein the position error is corrected with respect to a second direction perpendicular to the first direction.
